(19) United States
(12) Patent Application Publication
(10) Pub. No.: US 2007/0275735 A1
(43) Pub. Date: Nov. 29, 2007

(54) MAP INFORMATION COMMUNICATED VIA A WIRELESS SYSTEM

(75) Inventor: Leonardo W. Estevez, Rowlett, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS, INC., Dallas, TX (US)

(21) Appl. No.: 11/419,792

(22) Filed: May 23, 2006

(51) Int. Cl. H04Q 7/20

(52) U.S. Cl. 455/457; 340/10.1; 455/553.1

(57) ABSTRACT

A mobile device comprises host logic and a first transceiver coupled to the host logic. The first transceiver is adapted to wirelessly communicate with a second transceiver. The second transceiver is positioned at a fixed location and comprises location information indicative of such fixed location and map information. The first transceiver transmits wireless beacon signals. When the second transceiver is within range of the first transceiver, the beacon signal automatically causes the second transceiver to transmit the location and map information to the first transceiver.

### BACKGROUND OF THE INVENTION

1. Technical Field

The present disclosure relates generally to providing map information to a mobile device via a wireless communication system. More particularly, the present disclosure relates to providing such map information using a short-range communication system, such as a radio frequency identification (RFID) based system.

2. Background Information

Various types of location-determining systems exist. A global positioning system (GPS), for example, uses a network of satellites in earth orbit that transmits signals at a known time. A GPS receiver on the ground measures the time of arrival of the signals from each satellite that the receiver can “see.” The time of arrival of the signal along with the location of the satellites and the time the signal was transmitted from each satellite are used to triangulate the absolute position of the GPS receiver. A GPS receiver uses four or more satellites to make a triangulation. A GPS-based device generally requires a direct line-of-sight to the satellites. Such devices, therefore, generally do not work inside buildings or other structures that block signals to/from the satellites. That being the case, a user of a mobile GPS device will be unable to determine his or her location within a building.

### BRIEF SUMMARY

In general, various apparatus and methods are described. In one embodiment, a mobile device comprises host logic and a first transceiver coupled to the host logic. The first transceiver is adapted to wirelessly communicate with a second transceiver. The second transceiver is positioned at a fixed location and has access to location information indicative of such fixed location and map information. The first transceiver transmits wireless beacon signals. When the second transceiver is within range of the first transceiver, the beacon signal automatically causes the second transceiver to transmit the location and map information to the first transceiver.

In accordance with yet another embodiment, a communication device comprises a transceiver and storage. The storage comprises location information indicative of the location of the communication device and comprising map information. Upon receiving a wireless signal from a mobile wireless device, the transceiver responds by transmitting its location and map information to the mobile wireless device.

In accordance with yet another embodiment, a method comprises detecting a wireless signal and, upon detecting the wireless signal, automatically retrieving a location of a fixed position wireless communication device and retrieving map information. The method further comprises transmitting the location and the map information to a mobile wireless communication device.

### Notation and Nomenclature

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### BRIEF DESCRIPTION OF THE DRAWINGS

For a more detailed description of the preferred embodiments of the present invention, reference will now be made to the accompanying drawings, wherein:

FIG. 1 shows a system in accordance with preferred embodiments of the invention;

FIG. 2 illustrates map information used in accordance with preferred embodiments of the invention; and

FIG. 3 shows a method in accordance with embodiments of the invention.

### DETAILED DESCRIPTION OF THE PREFERRED EMBODIMENTS

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

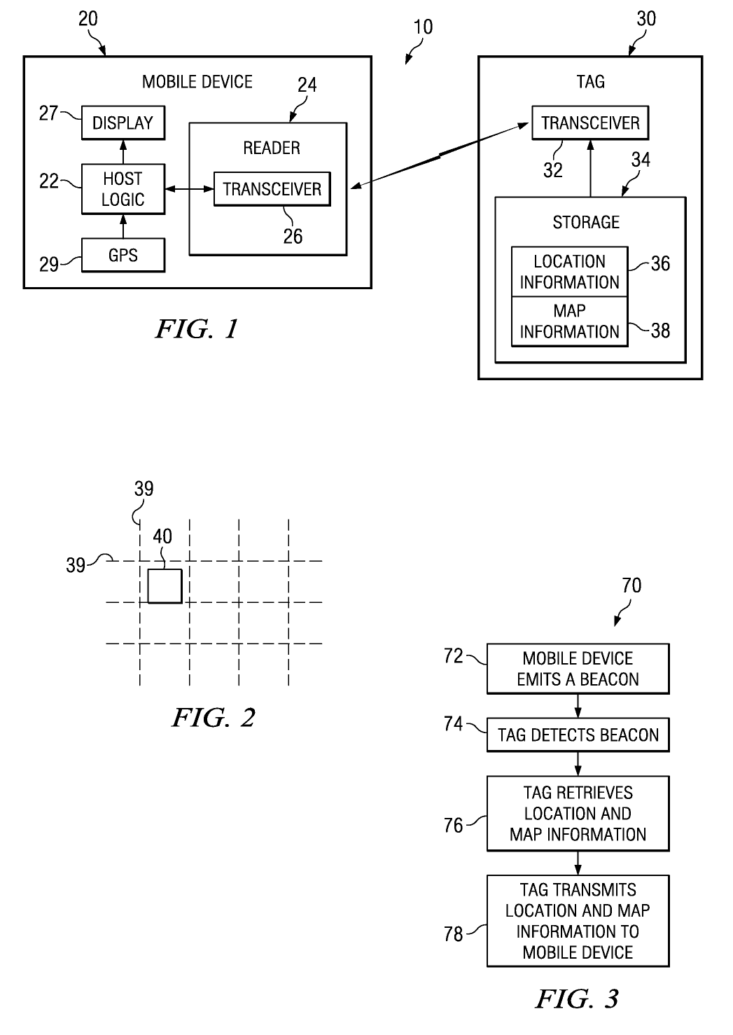

FIG. 1 shows a system 10 in accordance with preferred embodiments of the invention. The system 10 preferably comprises one or more wireless communication devices such as a mobile device 20 and a “tag” 30. The mobile device 20 comprises host logic 22 and a reader 24 which, in turn, comprises a transceiver 26. The mobile device 20 also comprises, or has access to, a display 27 and a global positioning system (GPS) receiver 29, which couple to host logic 22. The tag 30 comprises a transceiver 32 and storage 34. If desired, other components may be included with the mobile device 20 and tag 30.

The mobile device 20 may comprise any of a variety of mobile devices such as cellular telephones, personal digital assistants (PDAs), computers, etc. The host logic 22 performs one or more functions associated with the general functionality of the mobile device. For example, in the case of a cellular telephone, the host logic 22 may comprise a radio (preferably separate and apart from the transceiver 26), a keypad, a display, and control logic (e.g., a processor) to control the operation of the cellular telephone. In the case of a PDA or computer, the host logic 22 comprises a processor, memory, and other components typical of such devices.

The GPS receiver 29 receives signals from multiple GPS satellites in earth orbit and processes such signals to determine the location of the receiver 29, and thus the mobile device 20. The location is provided to or computed by the host logic 22. The GPS receiver 29, however, is not able to determine the mobile device's location if the mobile device is blocked from receiving the satellites' signals, such as by a structure. For example, the GPS receiver 29 may not be able to function if the mobile device is inside a building. As explained below, location and map information transmitted from the tag 30 to the mobile device's reader 24 solves, or at least ameliorates, this problem.

Via the transceivers 26 and 32, the mobile device 20 and tag 30 wirelessly communicate with each other. In accordance with one embodiment of the invention, the reader 24 of the mobile device and the tag 30 are provided in accordance with the radio frequency identification (RFID) protocol. As such, the reader 24 comprises an RFID reader and the tag 30 comprises an RFID tag. Unless otherwise specified, as used herein, the term “tag” is not limited to the RFID context. The tag 30 preferably is positioned at a fixed location such as on a wall, furniture, or piece of equipment. In other embodiments, the mobile device 20 comprises a tag and the system 10 comprises a reader that is positioned at a fixed location. Other embodiments comprise wirelessly devices other than RFID-based devices. For example, the mobile device 20 may comprise an ultra wide band (UWB) transceiver which wirelessly communicates with another UWB transceiver positioned at a fixed location.

As explained above, the tag 30 is positioned at a fixed and known location. The location of the tag can be denoted in accordance with a variety of techniques such as longitude and latitude coordinates, relative location to another known location, etc. Location information 36 indicative of the location of the tag 30 is stored in the tag's storage 34 and, as such, is accessible to the transceiver 26. The storage may comprise any suitable type of storage medium such as random access memory (RAM), flash memory, electrically erasable read-only memory (EEPROM), etc., and/or combinations thereof. The location information 36 indicative of the tag's location is loaded into storage 34 in accordance with any of a variety of techniques. For example, the location information can be wirelessly transmitted to the tag's transceiver 32 from a programming device (not specifically shown).

Map information 38 is also stored in the tag's storage 34 and, as such, is accessible to the transceiver 32. In some embodiments, the map information 38 is compressed (e.g., JPEG), although compression is not required. The map information 38 comprises map data pertaining to an area around the tag. The area may comprise an immediate area or the area of the entire building (or other designated locality) in which the tag is located. The map information 38 may comprise a vector drawing, a bit map, or any other suitable representation or format. FIG. 2 shows an example of map information 38 illustrating horizontal and vertical lines 39 of an area of a structure in which the tag is located and depicting the location 40 of the tag itself within the map information. The horizontal and vertical lines 39 represent, for example, hallways within a building.

In accordance with embodiments in which the mobile device 20 and tag 30 are RFID-compliant, the reader 24 emits a periodic wireless beacon signal that, when in range of transceiver 32 causes the tag 30 to automatically echo back a wireless response signal along with an identifier associated with the tag. In at least some embodiments, the identifier differentiates each tag 30 from other tags (to the extent there are other tags). Upon receipt of the response signal, the mobile device 20 is able to determine that the mobile device is within range of the tag 30. The tag 30 also retrieves its location information 36 and map information 38 from storage 34 and transmits the location information 36 and map information 38 to the mobile device's reader 24. The location and map information is transmitted within the response signal or as part of a separate wireless transmission. Moreover, the beacon signal emitted by the reader 24 preferably automatically causes the tag's transceiver 32 to transmit the tag's location information 36 and map information 38 to the reader's transceiver 26. The beacon signal may be automatically emitted at predetermined fixed or programmable periodic intervals. Additionally or alternatively, the mobile device 20 can be manually activated by its user to emit a beacon.

In some embodiments, the tag 30 is passive (i.e., the tag does not have its own source of power) and in other embodiments, the tag is active (i.e., has its own source of power). In accordance with at least some embodiments, the range at which the mobile device 20 and tag 30 can engage in effective communications depends on whether the tag is passive or active as well as one or more other factors such as the communication frequency, the transmit power, etc. In embodiments in which the tag is passive, communications are limited to less than about 3 meters and in some embodiments 2 feet or less, while if the tag is active, communications are limited to less than about 200 feet. In either case, once the mobile device 20 has been informed of the location of the tag 30, the location of the mobile device 20 is then known, estimated, or inferred, at least within the effective communication range of the tag. For example, if the effective communication range is 3 meters or less, then the mobile device knows its location to be within 3 meters of the location of the tag.

The mobile device 20 (e.g., the host logic 22) determines the type of tag (e.g., passive or active) to which it communicates. Based on the tag type, the mobile device 20 infers or estimates its location based on the received tag's location information. In some embodiments, the mobile device's host logic 22 and/or reader 24 determines the type of tag to which it communicates based on, for example, an aspect of the communication transmission (e.g., frequency), while in other embodiments, the mobile device can only communicate with one type of tag (active or passive). In this latter embodiment, the host logic and/or reader inherently knows the mobile device is communicating with a particular type of tag and thus its location range from the tag's position. Further still, in those embodiments in which the mobile device comprises the tag, the host logic knows that the mobile device has a particular type tag and thus can estimate its location accordingly.

In some embodiments, Near Field Communication (NFC) Transceivers and Tags can be used. NFC transceivers and tags operate at relatively short range. Such devices can function as either transceivers (active mode) or passive tags with an on-demand response. An on-demand response refers to a passive mode in which one device generates the RF field while the other device uses load modulation to transfer the data. NFC-enabled devices are generally interoperable with contactless smart-cards and smart-card readers conforming to these protocols. The effective communication range for NFC-based devices is generally less than about 1 foot and in some embodiments less than about 8 inches.

Communication is terminated either by a command from the application or when devices move out of range. In accordance with such embodiments, a user of an NFC-enabled mobile device could move his mobile device (e.g., cellular telephone) in proximity of an NFC transceiver or tag, for example, to purposely sync his or her position or this might happen automatically as he or she is purchasing an item at a store.

FIG. 3 illustrates a corresponding method 70. At 72, the mobile device emits a beacon signal. The beacon signal is detected by the tag at 74. In some embodiments, such as those described above, the beacon signal cannot be detected by the tag until the mobile device is within range (e.g., within 3 meters, 200 feet, or 1 foot as noted above) of the tag. The tag retrieves its location and map information at 76 and transmits its location and map information to the mobile device 20 at 78.

Once having received the tag's location information 36 and map information 38, the mobile device 20 (e.g., the host logic 22) estimates its location as explained above. Further, the mobile device shows the map information 38 on display 27, thereby permitting the user to see a map of the area and his or her location within that area. The mobile device 20 is thus able to indicate its location within the context of a map to the user of a GPS-enabled device especially when such GPS-enable device is unable to receive sufficient satellite signals to otherwise ascertain its location.

In some embodiments, a building comprises multiple tags 30 mounted at various locations. Each such tag comprises map information 38 and location information 36 customized to that particular tag. As the user transports the mobile device 20 around the structure and communicates individually with the various tags, the mobile device 20 is able to show a map of the area with the mobile device's location, at least at the time that the mobile device 20 received the location and map information from a tag 30.

In accordance with some embodiments, the GPS receiver 29 in the mobile device 20 automatically begins scanning for satellites after the mobile device no longer detects the presence of RFID tags with map information 38. For example, if a mobile device 20 that is inside a building and receiving map information 38 from tags 30 is taken outside and away from such tags, the GPS receiver 29 in the mobile device 20 will begin its satellite searching protocol.

It is possible that the GPS receiver 29 is able to determine location by accessing satellite signals while the reader 24 is able to receive map information 38 from a tag 30. In some embodiments, the mobile device 20 could be programmed to grant priority to one type of location technique or the other. That is, the GPS receiver 29 could be granted priority over the reader 24, or vice versa, in terms of which location information (coordinates from the GPS receiver or map information via the reader) is to be used or displayed on the mobile device.

In some embodiments, the map information 38 is prestored in each tag 30. In other embodiments, a person could load the map information 38 into a particular tag 30 as follows. With a computing/communication device, such as a PDA, a person could launch an application that pulls up a map of the user's surrounding environment (e.g., a building). The user could then use a pointing device (e.g., a stylus) to identify his or her location on the PDA. Before or after the aforementioned process, the user installs a tag at that general vicinity (i.e., the vicinity at which the user interacts with the PDA to designate his/her location). Once the tag is installed (e.g., mounted on a wall) and the user's location is identified to the PDA, the application running on the PDA preferably loads map information along with the identified location to the tag.

While the preferred embodiments of the present invention have been shown and described, modifications thereof can be made by one skilled in the art without departing from the spirit and teachings of the invention. For example, the communication between the communication device and tag/reader can be infra-red (IR)-based instead of radio frequency (RF)-based as in the case of RFID. The scope of protection is not limited by the description set out above. Each and every claim is incorporated into the specification as an embodiment of the present invention.

What is claimed is:

1. A mobile device, comprising:
host logic; and
a first transceiver coupled to said host logic and adapted to wirelessly communicate with a second transceiver, said second transceiver positioned at a fixed location and having access to location information indicative of said fixed location and having access to map information;
wherein said first transceiver transmits a wireless signal and, when the second transceiver is within range of the first transceiver, said wireless signal automatically causes the second transceiver to transmit said location information and said map information to the first transceiver.

2. The mobile device of claim 1 wherein said map information comprises a vector drawing format or a bit map.

3. The mobile device of claim 1 wherein said first transceiver is part of a device that is selected from a group consisting of a radio frequency identification (RFID) reader and a near field communication device.

4. The mobile device of claim 1 wherein a range of communications between said first and second transceivers is less than about 3 meters.

5. The mobile device of claim 1 wherein a range of communications between said first and second transceivers is less than about 200 feet.

6. The mobile device of claim 1 further comprising a display coupled to said host logic, said host logic shows said map information on said display.

7. The method of claim 6 wherein said display also indicates an estimated position of the mobile device on said map information.

8. The mobile device of claim 1 wherein said host logic estimates a location for said mobile device based on the location information.

9. The mobile device of claim 1 wherein said second transceiver having one of a plurality of types and said host logic estimates a location for said mobile device based on the location information and the type of said second transceiver.

10. The method of claim 1 further comprising a global positioning system (GPS) receiver.

11. A communication device, comprising:
a transceiver; and
storage comprising location information indicative of the location of the communication device and comprising map information;
wherein, upon receiving a wireless signal from a mobile wireless device, said transceiver responds by transmitting its location and map information to said mobile wireless device.

12. The mobile device of claim 11 herein said map information comprises a vector drawing format or a bit map.

13. The communication device of claim 11 wherein a range of communication between the communication device and the mobile wireless device is less than about 3 meters.

14. The communication device of claim 11 wherein a range of communication between the communication device and the mobile wireless device is less than about 200 feet.

15. The communication device of claim 11 wherein said communication device comprises a radio frequency identification (RFID) tag or RFID reader.

16. A method, comprising:
detecting a wireless signal;
upon detecting said wireless signal, automatically retrieving a location of a fixed position wireless communication device and retrieving map information; and
transmitting said location and said map information to a mobile wireless communication device.

17. The method of claim 16 wherein said map information comprises a vector drawing format or a bit map.

18. The method of claim 16 wherein detecting a wireless signal comprises detecting a periodic beacon signal.

19. The method of claim 16 further comprising displaying said transmitted map information on said mobile wireless communication device.
